(19) United States
(12) Patent Application Publication
(10) Pub. No.: US 2024/0312080 A1
(43) Pub. Date: Sep. 19, 2024

(54) DYNAMIC MESSAGING TO MULTIPLE VIEWERS

(71) Applicant: International Business Machines Corporation, Armonk, NY (US)

(72) Inventors: Jignesh K Karia, Thane (IN); Mukundan Sundararajan, Bangalore (IN); Pankaj Satyanarayan Dayama, Bangalore (IN); Shilpa Shetty, Sydney (AU); NEHA SHAH, Kolkata (IN)

(21) Appl. No.: 18/183,289

(22) Filed: Mar. 14, 2023

(51) Int. Cl. G06T 11/20; G06F 3/14; G06F 3/16; G09F 9/30; G09F 27/00

(52) U.S. Cl. CPC G06T 11/206; G06F 3/14; G06F 3/165; G09F 9/30; G09F 27/00; G09F 2027/001

(57) ABSTRACT

According to one embodiment, a method, computer system, and computer program product for public messaging to multiple viewers is provided. The embodiment may include identifying a public messaging display. The embodiment may also include collecting information about one or more viewers in a public place. The embodiment may further include assigning weights to one or more messages based on the collected information. The embodiment may also include determining an optimal message layout on the public messaging display based on the assigned weights. The embodiment may further include presenting the optimal message layout on the public messaging display.

### BACKGROUND

The present invention relates generally to the field of computing, and more particularly to digital signage.

Digital signage is an approach to providing information to many people at once. Digital signage devices may include displays, including monitors and LED displays, or speaker systems. Digital signage systems may operate on the internet, a local area network (LAN), or an edge computing network, and may use technologies such as the internet of things (IOT). Such technologies may allow a digital signage system to display multiple messages to multiple viewers, for example, by cycling between different messages over time. Accordingly, digital signage can be an effective communication technique in a public place, office, or similar environment with many potential viewers. Further, digital signage can be efficient compared to traditional paper signage, where each sign is static and creates paper waste.

### SUMMARY

According to one embodiment, a method, computer system, and computer program product for public messaging to multiple viewers is provided. The embodiment may include identifying a public messaging display. The embodiment may also include collecting information about one or more viewers in a public place. The embodiment may further include assigning weights to one or more messages based on the collected information. The embodiment may also include determining an optimal message layout on the public messaging display based on the assigned weights. The embodiment may further include presenting the optimal message layout on the public messaging display.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for dynamic messaging to multiple viewers.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to digital signage. The following described exemplary embodiments provide a system, method, and program product to, among other things, provide dynamic messaging to multiple viewers at once. Therefore, the present embodiment has the capacity to improve the technical field of digital signage by allowing a digital signage system to account for and communicate to multiple viewers at the same time.

As previously described, digital signage is an approach to providing information to many people at once. Digital signage devices may include displays, including monitors and LED displays, or speaker systems. Digital signage systems may operate on the internet, a local area network (LAN), or an edge computing network, and may use technologies such as the internet of things (IoT). Such technologies may allow a digital signage system to display multiple messages to multiple viewers, for example, by cycling between different messages over time. Accordingly, digital signage can be an effective communication technique in a public place, office, or similar environment with many potential viewers. Further, digital signage can be efficient compared to traditional paper signage, where each sign is static and creates paper waste.

Digital signage may be used to provide directions, transit schedules, advertising announcements, or other forms of public messaging to multiple viewers. However, known digital signage systems may only display a limited number of distinct messages at once. Existing solutions may further fail to provide information relevant to viewers. As such, it may be advantageous to dynamically select messages for multiple distinct viewers simultaneously.

According to one embodiment, a program for dynamic messaging to multiple viewers is provided. The dynamic messaging program may involve identifying one or more public messaging displays. The dynamic messaging program may then involve collecting anonymized information about viewers in public places according to opt-in procedures using a telecommunication services provider's scrubbing service. The dynamic messaging program may further involve assigning weights to messages based on collected information. A weight may, for example, represent a bid. Finally, the dynamic messaging program may determine and present an optimal message layout based on weights.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

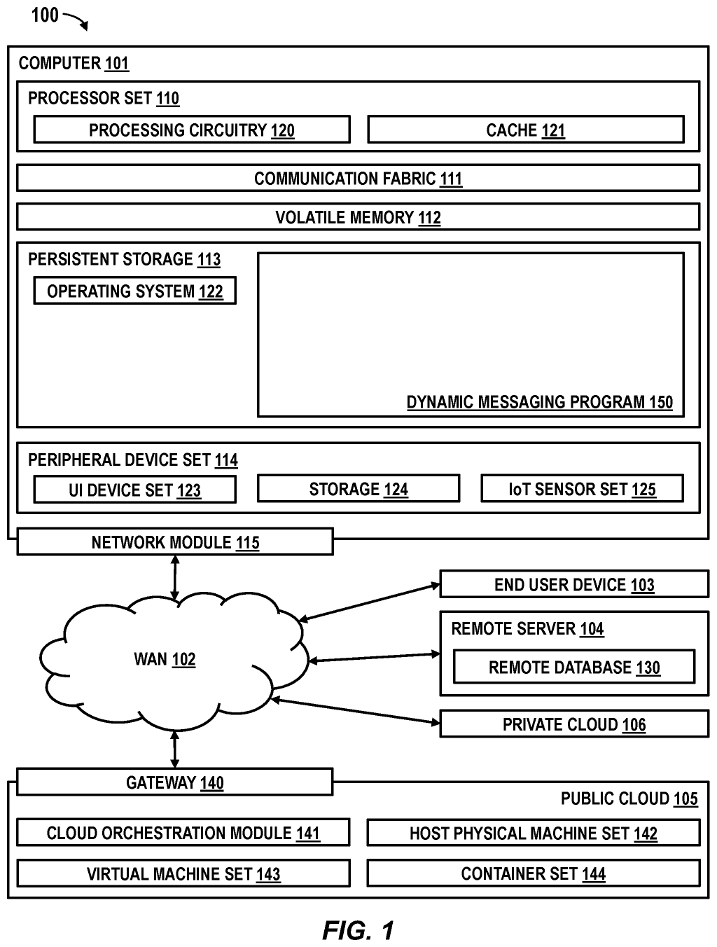

Referring now to FIG. 1, computing environment 100 contains an example of an environment for the execution of at least some of the computer code involved in performing the inventive methods, such as dynamic messaging program 150. In addition to dynamic messaging program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and dynamic messaging program 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed conversation is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in dynamic messaging program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in dynamic messaging program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The dynamic messaging program 150 may identify one or more public messaging displays. The dynamic messaging program 150 may then collect anonymized information about viewers in public places according to opt-in procedures using a telecommunication services provider's scrubbing service. The dynamic messaging program 150 may use the collected information to provide weights to messages representing a value for displaying those messages. The dynamic messaging program 150 may then determine one or more optimal message layouts based on weights, presenting the determined layout on the one or more public messaging displays.

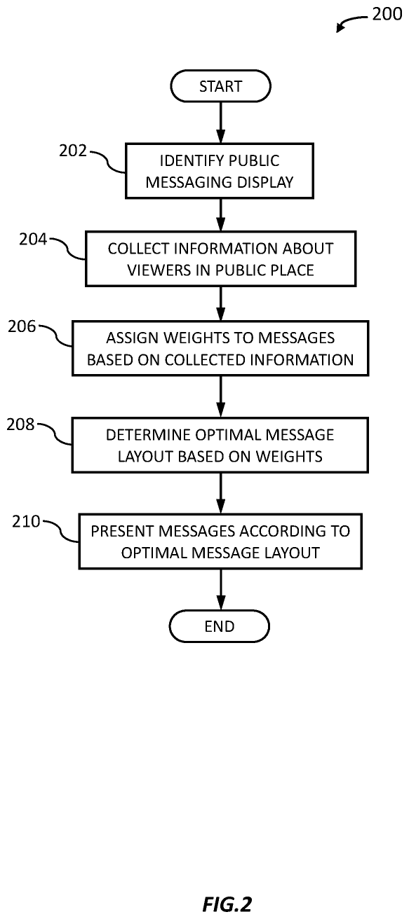

Furthermore, notwithstanding depiction in computer 101, dynamic messaging program 150 may be stored in and/or executed by, individually or in any combination, end user device 103, remote server 104, public cloud 105, and private cloud 106. The real-time navigation method is explained in more detail below with respect to FIG. 2.

Referring now to FIG. 2, an operational flowchart for a process for dynamic messaging to multiple viewers process 200 is depicted according to at least one embodiment. At 202, the dynamic messaging program 150 identifies one or more public messaging displays. A public messaging display may be, for example, a billboard, a street-level signage board, a transit display as may be used in a train station or airport, a sign or map in a shopping mall, or any other form of digital signage.

In at least one embodiment, a display may be, for example, a typical computing display unit or monitor, including a liquid crystal display (LCD), light emitting diode (LED), organic LED (OLED), active matrix OLED, Micro-LED, or quantum dot display; a projector display unit; a cathode ray tube display unit; or an array of multiple display units. An array of displays may include, for instance, an array of multiple rectangular display units arranged to look like one large display, or a series of individual LEDs arranged behind key points, such as color- coded LEDs at key points on a map display. As another alternative, a display may be an analog display cycling through physical advertisements at the direction of a computerized device capable of taking direction from the dynamic messaging program 150.

In at least one embodiment, a display may include or be communicatively coupled with a speaker or similar audio device, or an array of multiple such devices.

In an alternate embodiment, a display may further include or be communicatively coupled with one or more sensors, including a thermometer, other weather sensors, a microphone, a camera, or a touch sensor, such as a touch sensor corresponding to the display.

Then, at 204, the dynamic messaging program 150 collects anonymized data about one or more viewers in a public place using a telecommunication services provider's scrubbing service. Data may be collected according to opt-in procedures. A viewer may be a current viewer or a potential viewer. A telecommunication services provider may include a mobile services provider, home internet service provider, or other wireless network provider that has a scrubbing service. A scrubbing service may be any service that anonymizes data or provides anonymized data in a manner consistent with opt-in procedures.

In at least one embodiment, data may be collected according to opt-in procedures. For example, a viewer may opt in to data collection using a client application or a web application in association with dynamic messaging to multiple viewers. Data may be anonymized to whatever degree necessary to respect the privacy of viewers. Data may be anonymized using a telecommunication services provider's scrubbing service, at a stage before reaching the scrubbing service, later by the dynamic messaging program 150, or at multiple stages of the process for dynamic messaging to multiple viewers 200.

Collected data may include non-identifying data about a viewer indicating a viewer's demographics, interests, transit plans, or the present locations of viewers. For example, collected data may indicate that a viewer in an airport has a ticket for a particular flight. Data about the present locations of viewers may include data collected with the Global Positioning System (GPS), geofencing, triangulation, and similar methods, alongside measurements about a viewer's direction, speed, and acceleration, as may be collected by a viewer's device measurements to predict a viewer's likely location going forward.

In another embodiment, the dynamic messaging program 150 may collect additional data. Additional data may include data about overall vehicle traffic or foot traffic in an area including road closures, map information about a nearby area such as a list of nearby stores or transit terminals, weather conditions, and noise conditions near the display. Additional data may be connected from internet sources including public and private APIs, sensors included in or communicatively coupled with the display, and private data sets, or any other source that might provide useful data.

In at least one embodiment, a viewer may include a person currently in visible or audible range of a display. A viewer may further include a potential viewer, which may include anybody in or near the public place who might be likely to become a current viewer. A viewer may be, for example, a pedestrian or a passenger in a vehicle. Viewers may be represented by unique, anonymous identifiers, such as V₁. . . Vₙ for n users, randomized numerical identifiers, pseudonyms with letters and numbers, or any other identifying label.

In at least one embodiment, a public place may be any area within visible or audible range of a public messaging display, or an area from which viewers might be likely to approach, find, or notice a public messaging display. Likelihood of approaching, finding, or noticing a display may be measured in any way, including by a probability, by a binary measure, by a threshold measurement, or by any other useful measurement.

In a further embodiment, collected data may include feedback about the dynamic messaging program 150. Feedback may be used in machine learning, or may be used to modify the weights of messages. For example, if viewers provide feedback suggesting that a given message is offensive, the weight of that message may be reduced or set to zero at 206.

Next, at 206, the dynamic messaging program 150 assigns weights to messages based on collected information. A message may be any piece of information a speaker would like to provide to one or more viewers, such as an advertisement, transit schedule information, directions, traffic information, or announcements. Speakers may include, for example, advertisers, transit agencies, airlines, or government agencies. A weight may be a bid or value assigned by a speaker, or may be assigned by an algorithmic process, such as a process of artificial intelligence.

In at least one embodiment, assigning weights to messages may include identifying one or more speakers. Speakers may include, for example, advertisers, transit agencies, airlines, or government agencies. Speakers may be identified through various methods, such as by signing up for dynamic messaging or by placing bids. Speakers may be represented by a unique identifier, such as S₁. . . Sₘ.

In another embodiment, messages may be defined specifically, algorithmically, or hypothetically. A specific message may be a message that already exists. An algorithmic message might be defined using an algorithm, and may be defined using collected data. An algorithm may poll a weather API or generate the most effective message possible using artificial intelligence, or generate parts of a message. An algorithmic message may be defined at any point in time before a message is presented at 210, may be redefined at any point in time, and may be defined or redefined in response to any event. A hypothetical message may be a message that does not yet exist, such as a placeholder for a message where a speaker places a bid for space for an advertisement that does not yet exist.

In yet another embodiment, messages may be identified by a speaker or by an algorithmic process, or may be predetermined. For example, Speaker-identified messages may include advertisements, transit schedule information, or announcements. An algorithmically defined message may be generated algorithmically or selected from a set of specific preexisting messages, and may include directions, the current time, traffic information, or weather information. A predetermined message may include a welcome message welcoming viewers to a town they are entering.

Messages may further be defined in multiple sizes, aspect ratios, or formats. Messages may be represented by unique identifiers such as M₁. . . Mₚ.

A weight may be a bid or value assigned by a speaker, or may be assigned by an algorithmic process, such as a process of artificial intelligence. Alternatively, an organization may place bids to place an image or a video on a display for a given amount of space and time. As another alternative, a city may place a standing low weight to show the city's welcome sign on a billboard when there are no sufficiently high bids from other speakers.

Weights may be bids placed using a dedicated credit system for dynamic messaging. For example, different airlines may place bids using an airport credit system to present information about their flights to viewers. Alternatively, credits may be distributed evenly to clubs at a university or departments in a business's office building, and then displayed in the lobby of the student union or the lobby of the office building, respectively.

Weights may be determined in response to collected information. For example, collected information may identify 18 viewers in an area surrounding screen S in terminal B of an airport, where six viewers have tickets to flight B51, four viewers have tickets to flight B52, three viewers have tickets to flight B53, and five viewers have tickets to flight B54, messages providing information about flights may be assigned weights equal to the number of viewers with tickets to their respective flights. As an alternate example, the dynamic messaging program 150 may provide anonymous collected information to advertisers, and advertisers may place bids according to which ads they believe may be most valuable given collected information about one or more viewers. As yet another algorithm, advertisers may bid on a given period of time based on the number of cars that will be lined up behind a toll booth, or the number of viewers that will be behind that toll booth, in visible range of a billboard over that toll booth.

Weights may be determined according to an algorithmic process. For example, weights may be determined by a process of artificial intelligence, which may utilize such techniques as machine learning, deep learning or an artificial neural network. As another example, a weight for an advertisement may be generated based on advertiser bids and a weight for a traffic update may be generated based on a process of artificial intelligence, and these weights may be determined in a manner that balances the importance of the different types of messages onto one coherent scale. An algorithm may modify the weight corresponding to a bid by a speaker who is known to take advantage of the dynamic messaging program 150, for example by submitting messages to a shopping mall that violate the shopping mall's digital signage policy. As a further example, an algorithm may modify the weights of messages based on the amount of energy they are expected to consume.

A weight may be a number, a set of numbers, an equation, or an algorithm. For example, a weight may be a set of numbers signifying the weight to be assigned to messages of various sizes or various time lengths. For example, a speaker may bid $14 for a three second message, $26 for a six second message, or $200 for a twenty second message with audio. Alternatively, a speaker may bid $.0004 per square pixel per second plus $.60 per second for audio. As yet another example, a weight may include a short algorithm that may take as input the size of a message, the time of day, collected information, and the duration of a message to respond with the weight for that particular message. As a further example, a speaker may bid $.40 per second to have the speaker's store highlighted on a mall's map alone, $.25 per second to have the speaker's store as one of two stores that are highlighted on a map, $.10 per second if three stores are highlighted, $.02 per second if four stores are highlighted, and no bid if more than four stores are highlighted.

In a further embodiment, weights may be modified or adjusted over time. For example, weights may be modified by a process of artificial intelligence as a machine learning algorithm learns from collected data. Alternatively, weights may be modified so that messages are not repeated too frequently. For example, weights may all be temporarily reduced by 2 points per occasion in which a message was presented in the past ten minutes.

Weights may be represented by unique identifiers corresponding to messages, speakers, viewers, or a combination thereof, including representations such as W1 . . . Wm, W1 . . . Wp, W_{1,1} . . . W_{p,n}.

Then, at 208 the dynamic messaging program 150 determines an optimal message layout for one or more of the displays based on the assigned weights. Determining a layout may include subdividing a display into zones or identifying points of interest on a display. Determining a layout may also include selecting messages to fill those areas so as to maximize the weights of messages that can be presented. The optimal layout may be determined based on message features including a requested size, aspect ratio, duration, or size for the message, or an array of bids for different features of the same message.

Determining a layout may include subdividing a display into zones or identifying points of interest on a display. A zone may be defined in terms of shape and size or may further be defined according to a specific position on the display. For example, a zone on a display that is 16 feet wide and 9 feet tall may be 8 feet wide and 9 feet tall, 8 feet wide and 4.5 feet tall, 10 feet wide and 6 feet tall, or a circular zone with a radius of 3 feet and a center at the point 5 feet from the left of the screen and 4 feet down from the top of the screen. As another example, if a display is an array of display units, each individual display unit may be a zone. As yet another example, a zone may be a single pixel. As a further example, a zone may be an individual LED light placed under a point on a map corresponding to a store, kiosk, or other point of interest in a shopping mall. Zone sizes and shapes may be selected to match common sizes of messages.

Alternatively, determining a layout may include displaying an overlay. For example, displaying a layout may include drawing an overlay of directions on a map redirecting viewers so that they may avoid blocked roads, drawing a line with an arrow on a map in a shopping mall to direct users to a particular store in the shopping mall, or drawing sunlight or snow over a message comprising a clock to indicate weather conditions.

Determining a layout may also include selecting messages to fill zones so as to maximize the sum of weights of messages that can be presented, or maximizing the sum of weights given one or more constraints. Selecting messages may include selecting form factors for messages, sizes, and durations. Sizes and form factors may be selected to match the shapes and sizes of zones exactly or as closely as possible. A constraint may include, for example, a requirement that the time always be visible, that at least five safety messages must appear in any ten minute period, or a requirement that messages may not advertise certain products during times of the day when children are likely to be present.

In at least one embodiment determining the optimal layout may be framed as a 2-dimensional knapsack problem, and may be performed using known techniques for solving a 2-dimensional knapsack problem, such as an Increasing Height Shelf algorithm. Alternatively, determining the optimal layout may be framed as a multi-objective knapsack problem, a multi-dimensional knapsack problem, or other computationally similar problems. Solutions may include imperfect solutions, including solutions found using greedy algorithms or approximation algorithms.

The optimal layout may be determined given one or more fixed variables. For example, all messages may be ten seconds in length, and there may be fixed zones for messages with fixed padding between each message. The optimal layout may be determined based on message features including a requested size, aspect ratio, duration, or size for the message, or an array of bids for different features of the same message.

In another embodiment, determining the optimal layout may further include selecting from multiple predesigned layout styles, and selecting messages to fill the layout style. For example, a designer may design predesigned layout style A as a full-screen single-zone layout style, predesigned layout style B as a layout style with one zone at the top left of the display, one zone at the bottom left of the display, one zone taking up the right half of the display, and black borders in between the zones, and layout style C as a layout style that splits the display into four equal-sized zones in the top left, top right, bottom left, and bottom right, with no border in between the zones.

Building on the preceding example, if time is a fixed variable and there is no audio available, there may be four proposed quarter-screen messages with weights W₁₁=35, W_{2,1}=45, W_{3,1}=86, and W_{4,1}=24, two proposed half-screen messages with weights W_{1,2}=70 and W_{3,2}=132, and one proposed full-screen message with weight W_{1,4}=126, where W_{a,b} signifies the weight of message style a in a zone of size b, with a further constraint that the same message style may not be used twice in the same layout. In this case, the maximum weight of layout A may be 126 for a full-screen layout of message style 1; the maximum weight of layout B may be 212 for two quarter-screen messages M₁ and M₂ and one half-screen message M₃; and the maximum weight of layout C may be 190 as the combined weight for each quarter-screen message. Accordingly, the dynamic messaging program 150 may select the described maximum-weight layout instance of layout style B as the selected layout.

In an alternate embodiment, the optimal layout may be selected based on a modified total weight. For example, a modified total weight of a layout may be the sum of weights of the messages in the layout minus five points per occasion on which the layout has been used in the past ten minutes. Alternatively, a modified total weight may be determined based on a process of artificial intelligence based on the weights of the messages in the layout, the contents of the messages, and collected information.

The optimal layout may include fixed, always-present messages. For example, the optimal layout may include a permanent digital clock in the top left corner.

Next, at 210 the dynamic messaging program 150 presents the optimal layout dynamically. Presenting the optimal layout may include displaying the optimal layout on one or more displays, playing audio on one or more speakers, or synchronizing audio to video contents of a message.

A layout may refresh at predetermined intervals, such as once per second or once every six seconds; continuously; very frequently or substantially continuously, such as once every millisecond; or in response to any change in any factor described above. Refreshing a layout may cause a new layout to be displayed instantly, or through an animation.

Presenting an optimal layout may include animating a change in a layout. For example, if an optimal layout shows flight information for four trains, and the next optimal layout cycles out the top message and brings in a new message, the existing layout may slide upwards and the new message may slide in from the bottom. Animations may include moving, resizing, flipping, spinning, fading or transforming messages.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a public messaging display;
collecting information about one or more viewers in a public place;
assigning weights to one or more messages based on the collected information;
determining an optimal message layout on the public messaging display based on the assigned weights; and
presenting the optimal message layout on the public messaging display.

2. The method of claim 1, wherein the collecting further comprises:
collecting anonymous viewer information from a scrubbing service provided by a telecommunication services provider.

3. The method of claim 1, wherein the assigned weights correspond to a number of viewers.

4. The method of claim 1, wherein the assigned weights are determined based on a process of artificial intelligence using an artificial neural network.

5. The method of claim 1, wherein the optimal message layout is determined based on the total sum of weights of messages present in each possible layout.

6. The method of claim 1, wherein the optimal layout includes selecting audio to play over an audio device included in or communicatively coupled with the display.

7. The method of claim 1, wherein determining an optimal message layout further comprises determining an overlay to portray on the public messaging display.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a public messaging display;
collecting information about one or more viewers in a public place;
assigning weights to one or more messages based on the collected information;
determining an optimal message layout on the public messaging display based on the assigned weights; and
presenting the optimal message layout on the public messaging display.

9. The computer system of claim 8, wherein the collecting further comprises:
collecting anonymous viewer information from a scrubbing service provided by a telecommunication services provider.

10. The computer system of claim 8, wherein the assigned weights correspond to a number of viewers.

11. The computer system of claim 8, wherein the assigned weights are determined based on a process of artificial intelligence using an artificial neural network.

12. The computer system of claim 8, wherein the optimal message layout is determined based on the total sum of weights of messages present in each possible layout.

13. The computer system of claim 8, wherein the optimal layout includes selecting audio to play over an audio device included in or communicatively coupled with the display.

14. The computer system of claim 8, wherein determining an optimal message layout further comprises determining an overlay to portray on the public messaging display.

15. A computer program product, the computer program product comprising:
one or more computer-readable tangible storage medium and program instructions stored on at least one of the one or more tangible storage medium, the program instructions executable by a processor capable of performing a method, the method comprising:
identifying a public messaging display;
collecting information about one or more viewers in a public place;
assigning weights to one or more messages based on the collected information;
determining an optimal message layout on the public messaging display based on the assigned weights; and
presenting the optimal message layout on the public messaging display.

16. The computer program product of claim 15, wherein the collecting further comprises:
collecting anonymous viewer information from a scrubbing service provided by a telecommunication services provider.

17. The computer program product of claim 15, wherein the assigned weights correspond to a number of viewers.

18. The computer program product of claim 15, wherein the assigned weights are determined based on a process of artificial intelligence using an artificial neural network.

19. The computer program product of claim 15, wherein the optimal message layout is determined based on the total sum of weights of messages present in each possible layout.

20. The computer program product of claim 15, wherein the optimal layout includes selecting audio to play over an audio device included in or communicatively coupled with the display.
